(19) United States
(12) Patent Application Publication
(10) Pub. No.: US 2025/0278547 A1
(43) Pub. Date: Sep. 4, 2025

(54) AUTOMATED DATA TRANSLATION OF COLLABORATIVE PLATFORM COMMUNICATION

(71) Applicant: Wells Fargo Bank, N.A., San Francisco, CA (US)

(72) Inventors: Phani N. Kidambi, Lee, NH (US); David Price, Kennewick, WA (US)

(21) Appl. No.: 19/068,587

(22) Filed: Mar. 3, 2025

Related U.S. Application Data
(60) Provisional application No. 63/561,048, filed on Mar. 4, 2024.

(51) Int. Cl. G06F 40/103; G06F 9/54; G06F 16/21; G06F 40/123; G06F 40/166; G06F 40/205

(52) U.S. Cl. CPC G06F 40/103; G06F 9/547; G06F 16/212; G06F 40/123; G06F 40/166; G06F 40/205

(57) ABSTRACT

A method may include generating an API call to a collaborative document creation platform, the API call requesting comments made with respect to a document hosted by the collaborative document creation platform; transmitting the API call to the collaborative document creation platform; in response to the transmitting, receiving from the collaborative document creation platform, a data payload, the data payload identifying a communication made within the document and the communication formatted in a first data structure schema; transforming the communication formatted in the first data structure schema to a second data structure schema; and storing the communication formatted in the second data structure schema in an archive data store.

This patent application claims the benefit of U.S. Provisional Patent Application No. 63/561,048 titled “AUTOMATED DATA TRANSLATION OF COLLABORATIVE PLATFORM COMMUNICATION” filed Mar. 4, 2024, and which is herein incorporated by reference in its entirety

### BACKGROUND

Cloud-based collaborative platforms are designed to facilitate real-time interaction and teamwork on a variety of projects, including both text-based documents and graphical designs. In these environments, a document or design can be created and accessed by multiple users simultaneously, allowing for dynamic collaboration. Participants can make direct edits, add annotations, or leave comments on specific elements, which may be instantly visible to other collaborators. The platforms track changes and contributions, often providing version control and a history of interactions.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Like numerals having different letter suffixes may represent different instances of similar components. Some embodiments are illustrated by way of example, and not limitation, in the figures of the accompanying drawing.

FIG. 1 is an illustration of elements of an enterprise server and collaborative document creation platform and client devices, according to various examples.

FIG. 2 is a user interface and comment data structure, according to various examples.

FIG. 3 is an interactive communication analysis user interface, according to various examples.

FIG. 4 is a flowchart illustrating a method to translate comments between data structure schemas, according to various examples.

FIG. 5 illustrates an example method 500 for generating a communication network visualization, according to various examples.

FIG. 6 is a block diagram illustrating a machine in the example form of computer system, within which a set or sequence of instructions may be executed to cause the machine to perform any one of the methodologies discussed herein, according to various examples.

### DETAILED DESCRIPTION

In the following description, for purposes of explanation, numerous specific details are set forth in order to provide a thorough understanding of some examples. It will be evident, however, to one skilled in the art that the present invention may be practiced without these specific details. As such, references in the specification to “one example,” “an example,” “an illustrative example,” etc., indicate that the example described may include a particular feature, structure, or characteristic, but every example may or may not necessarily include that particular feature, structure, or characteristic. Moreover, such phrases are not necessarily referring to the same example. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

Throughout this disclosure, components may perform electronic actions in response to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. In some instances, user interfaces may be provided for an end-user or administrator to edit the variable values.

In various examples described herein, user interfaces are described as being presented to a computing device. The presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples, these portions may be displayed on a screen simultaneously, in others, the portions/elements may be displayed on separate screens such that not all portions/elements are displayed simultaneously. Unless explicitly indicated as such, the use of “presenting a user interface” does not infer either one of these options.

Additionally, the elements and portions are sometimes described as being configured for a particular purpose. For example, an input element may be configured to receive an input string. In this context, “configured to” may mean presenting a user interface element capable of receiving user input. Thus, the input element may be an empty text box or a drop-down menu, among others. “Configured to” may additionally mean computer executable code processes interactions with the element/portion based on an event handler. Thus, a “search” button element may be configured to pass text received in the input element to a search routine that formats and executes a structured query language (SQL) query to a database.

Regulatory requirements for communication archiving are often used to ensure transparency and accountability in business operations, especially in the financial sector. Governing bodies like the Financial Industry Regulatory Authority (FINRA) and the Securities and Exchange Commission (SEC) often mandate the retention of business-related communications in a non-rewriteable and non-erasable format. Accordingly, financial firms should have robust systems to monitor, archive, and retrieve all relevant electronic communications for audit purposes. Other regulations in the United States, such as the Sarbanes-Oxley Act (SOX) and the Dodd-Frank Act, along with others in the European Union, further underscore the importance of comprehensive record-keeping.

Capturing data for regulatory compliance from cloud-based collaborative platforms presents unique challenges not encountered with internal tools, even if those tools are cloud-based, like email. For example, internal tools are often designed with compliance requirements in mind. They typically include built-in logging, monitoring, and reporting features that align with an organization's governance policies. These tools can be configured to automatically capture and archive communications in a format that is readily accessible and auditable.

In contrast, external cloud-based collaborative platforms primarily focus on user experience and productivity rather than compliance with their users' regulatory rules. As such, the data structures of these platforms are optimized for performance and flexibility rather than for case of compliance.

Moreover, internal tools usually operate within a controlled IT environment. The organization has full governance over the data, including where it is stored, how it is secured, and who has access to it. This control simplifies enforcing compliance protocols and ensures data capture mechanisms are consistent with internal policies. On the other hand, data from cloud-based collaborative platforms is stored on servers operated by external vendors, which can be located in different jurisdictions with varying data protection laws. This can complicate compliance efforts, as the organization must navigate a patchwork of legal requirements while relying on the vendor's security measures to protect sensitive information.

Additionally, cloud-based collaborative platforms are often updated and improved rapidly, with new features and functionalities regularly introduced. Each update can potentially alter the way data is stored and managed, requiring continuous adjustments to the compliance capture and archiving processes.

Another significant challenge is the diversity of data types and interaction modes supported by collaborative platforms. For example, collaborative platforms may support text, images, videos, and complex document histories. Capturing this wide array of data in a compliant manner may need data translation processes to interpret and convert various data formats into a standardized archival schema.

Given these problems, the system described below facilitates storing electronic communications made between users or by users on collaborative document creation platforms. The system may initiate API calls to the platforms to retrieve comments made in or related to documents managed by the collaborative document creation platform. The system may parse and transform the data to fit an archival format. The system is designed to manage various data structures and user interactions, ensuring comprehensive capture and archival of communications. In various examples, the data is analyzed to identify all participants and filter out interactions that may not need to be stored.

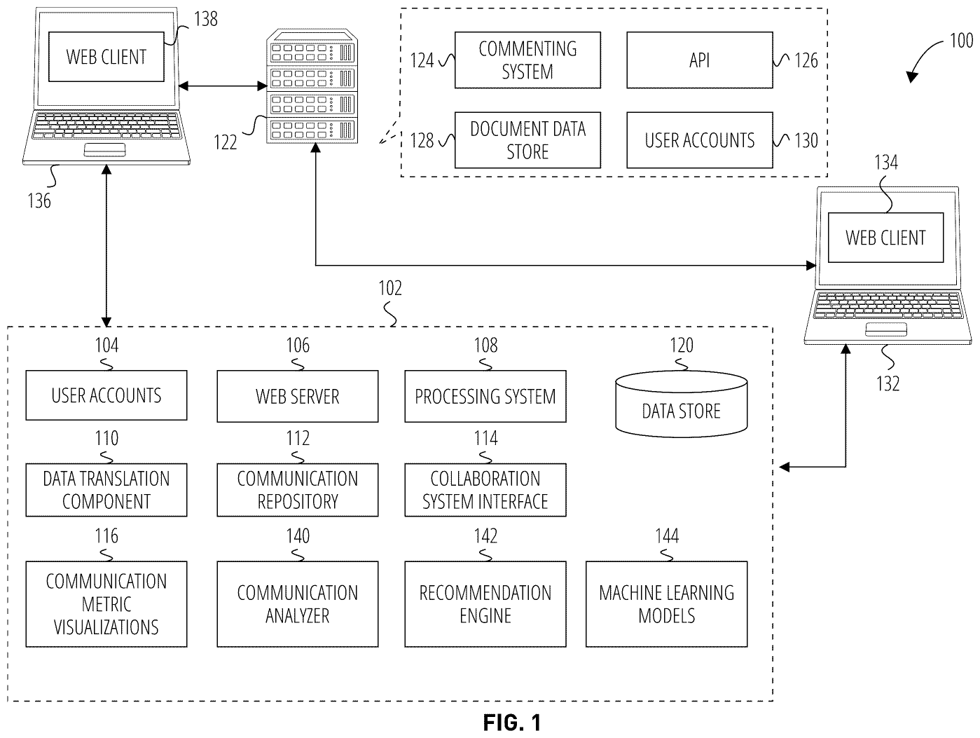

FIG. 1 is a diagram 100 of elements of an enterprise server and collaborative document creation platform and client devices, according to various examples. The diagram 100 is an example operating environment in which the enterprise server 102 may electronically communicate with the collaborative document creation platform 122 to retrieve user comments (using client device 136 and client device 132) on the collaborative document creation platform 122. The collaborative document creation platform 122 may provide a digital environment where users create and edit documents collaboratively. Users may use client device 136 and client device 132 to interact with platform 122 (e.g., using web clients 134 and 138).

The diagram 100 comprises an enterprise server 102, a user accounts 104, a web server 106, a processing system 108, a data translation component 110, a communication repository 112, a collaboration system interface 114, a communication metric visualizations 116, a data store 120, a collaborative document creation platform 122, a commenting system 124, an API 126, a document data store 128, a user accounts 130, a client device 132, a web client 134, a client device 136, and a web client 138.

Enterprise server 102 is illustrated as a set of separate elements. However, the functionality of multiple individual elements may be performed by a single element. An element may represent computer program code executable by processing system 108. The program code may be stored on a storage device (e.g., data store 120) and loaded into the memory of the processing system 108 for execution. Portions of the program code may be executed in parallel across multiple processing units. A processing unit may be one or more of the cores of a general-purpose computer processor, a graphical processing unit, an application-specific integrated circuit, or a tensor processing core operating a single device or multiple devices. Accordingly, code execution using a processing unit may be performed on a single device or distributed across multiple devices. In some examples, the program code may be executed on a cloud platform (e.g., MICROSOFT AZURE® and AMAZON EC2®) using shared computing infrastructure. Similarly, a single element may perform the combined functionality of multiple elements of collaborative document creation platform 122. Furthermore, although a processing system is not illustrated, computer code may be executed on a processing unit to perform the described functionality.

The client device 136 and the client device 132 may be computing devices which may be, but are not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., in the form of specially configured user interfaces). In some embodiments, computing devices may comprise one or more of a touch screen, camera, keyboard, microphone, or Global Positioning System (GPS) device.

The client device 136, the web client 138, the collaborative document creation platform 122, and the enterprise server 102 may communicate via a network (not shown). The network may include local-area networks (LAN), wide-area networks (WAN), wireless networks (e.g., 802.11 or cellular network), the Public Switched Telephone Network (PSTN) Network, ad hoc networks, cellular, personal area networks, or peer-to-peer (e.g., Bluetooth®, Wi-Fi Direct), or other combinations or permutations of network protocols and network types. The network may include a single Local Area Network (LAN) or Wide-Area Network (WAN), or combinations of LANs or WANs, such as the Internet.

In various examples, the user accounts 130 of the collaborative document creation platform 122 stores users' profile information, preferences, and access rights to documents in the document data store 128. Each user may be a unique user identifier. The user identifier of a user in user accounts 130 may be the same as that in a user account of the user accounts 104. For example, the user identifier may be an email address. In other examples, the user identifiers may be different. A user account may also include a group identifier. A group identifier may be a domain such as (@acme.com) or another common identifier associated with an enterprise that manages the users for the collaborative document creation platform 122. For example, the group identifier may be the domain of users' email addresses associated with the enterprise server 102.

The document data store 128 may store the content and metadata of all the documents for the collaborative document creation platform 122. A document in the document data store 128 may include a version history of each document and comments made within the document or that reference the document. Each document within the document data store 128 may have an automatically generated unique identifier, which is used to link comments and other interactions to the correct document.

Users may leave comments through the commenting system 124 as they interact with the documents. The commenting system 124 may monitor feedback, discussions, and annotations within the context of a document. The commenting system 124 may have a schema that includes a timestamp, comment content, the document's unique identifier, and a user's identifier from their user account in the user accounts 130. This association allows for a structured and organized way to track who made a comment, when it was made, and on which specific document.

In various examples, a comment made by a first user may include a reference to another user. For example, a comment may state, “@Jane, please look at the design of this component.” In such an instance, the comment within the commenting system 124 may include two user identifier associations: the first user and the second user.

The enterprise server 102 may be a server associated with an enterprise that has regulatory requirements to store communications. As indicated previously, enterprise server 102 may actually be thousands of computers responsible for the enterprise's information technology infrastructure. For example, enterprise server 102 may include e-mail services, etc.

The user accounts 104 within the enterprise server 102 may be a repository for managing employees' identities and access privileges within the enterprise organization. Each account in the user accounts 104 may be associated with a unique user identifier, such as an email address. In various examples, the user identifier in the user accounts 104 of the enterprise server 102 may be leveraged for single sign-on (SSO) to access the collaborative document creation platform 122. With SSO, users may log in once using their enterprise credentials and then gain access to multiple systems, including collaborative document creation platform 122, without the need to log in again for each system.

Enterprise server 102 may include a web server 106 to enable data exchanges with client device 136 and web client 134 via web client 134 and web client 138. Although generally discussed in the context of delivering webpages via the Hypertext Transfer Protocol (HTTP), other network protocols may be utilized by web server 106 (e.g., File Transfer Protocol, Telnet, Secure Shell, etc.). A user may enter a uniform resource identifier (URI) into web client 138 (e.g., the INTERNET EXPLORER® web browser by Microsoft Corporation or SAFARI® web browser by Apple Inc.) that corresponds to the logical location (e.g., an Internet Protocol address) of web server 106. In response, web server 106 may transmit a web page rendered on a client device's display device (e.g., a mobile phone, desktop computer, etc.).

The web server 106 may enable users to interact with one or more web applications provided on a transmitted web page. A web application may provide user interface (UI) components rendered on a display device of a client device 136. The user may interact (e.g., select, move, enter text into) with the UI components, and, based on the interaction, the web application may update one or more portions of the web page. A web application may be executed in whole or in part locally on client device 136. The web application may populate the UI components with data from external or internal sources (e.g., data store 120) in various examples. For example, enterprise server 102 may provide a web application for the enterprise's employees to access their email, documents, etc.

Collaboration system interface 114 may be configured to communicate with external services such as the collaborative document creation platform 122. In various examples, the communication is performed using Application Programming Interface (API) calls per the format of the API of the external service (e.g., API 126). The API 126 functions as a gateway for the enterprise server 102 to programmatically request and retrieve data from the collaborative document creation platform 122, including comments made on documents stored in the document data store 128.

An API provides a method for computing processes to exchange data. A web-based API (e.g., API 126) may permit communications between two or more computing devices, such as a client and a server. The API may define a set of HTTP calls according to Representational State Transfer (RESTful) practices. For example, a RESTful API may define various GET, PUT, POST, and DELETE methods to create, replace, update, and delete stored data (e.g., in the document data store 128).

When the enterprise server 102 aims to gather communication made in the collaborative document creation platform 122, an API request may be formatted. The request may include parameters such as user identifiers that match the user identifiers in the user accounts 130 or an enterprise identifier, a specified time period, and the requested data type (e.g., comments). The collaboration system interface 114 may encode these parameters into the API call, which is then transmitted to the collaborative document creation platform 122 via API 126.

For example, the API call may be structured as an HTTP GET request, where the URL encodes the parameters used by the collaborative document creation platform 122 to identify and retrieve the desired data. The enterprise identifier may be a unique key assigned to the organization, which ensures that only data associated with the enterprise's user accounts is accessed. The time period parameter may specify the range of dates and times (e.g., for a day) for which the comments are requested. The type parameter may be set to ‘comments’ to indicate that the request is specifically for comment data rather than document content or other data types. An example of such an API call might look like this: GET *.collabdocplatform.com/v1/comments?enterprise_id=WF-ENT-001&start_time=2023-09-01T00:00:00Z&end_time=2023-09-01T23:59:59Z&type=comments. Other parameters may also be included in the API call. For example, a project identifier may be included to retrieve comments associated with specific projects or workspaces with a platform. The API call may include one or more user identifiers to retrieve comments limited to those user identifiers.

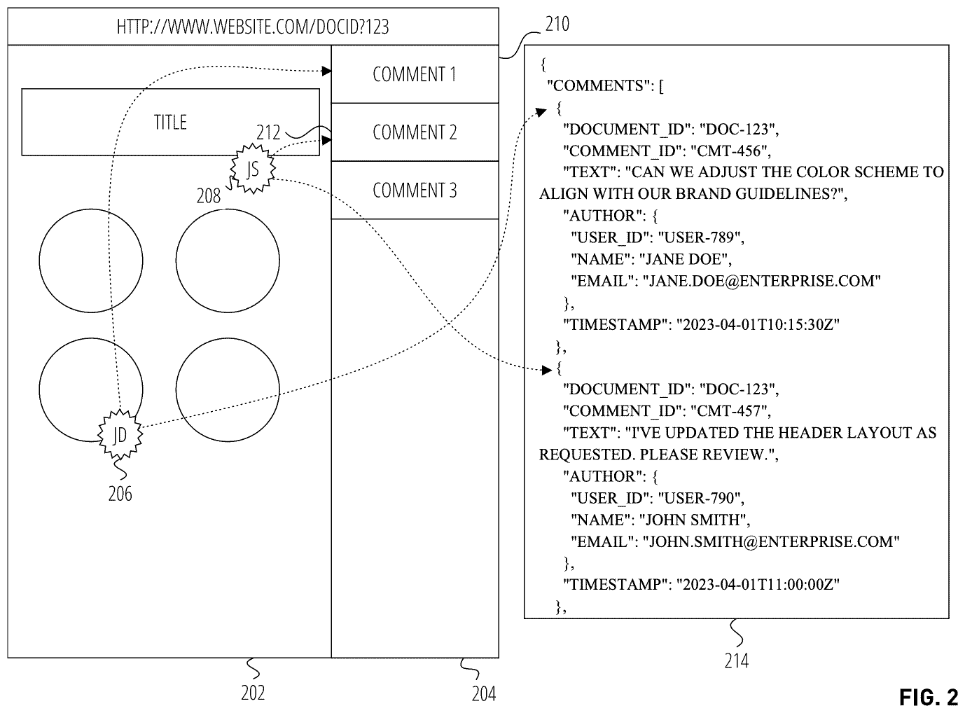

Before sending the API call, the collaboration system interface 114 may also include authentication information, such as an OAuth token, in the HTTP request header to ensure the request is authorized. The header might also specify the expected response format, such as JavaScript Object Notation (JSON), for easy parsing and data manipulation. Once the API call is constructed, it is transmitted over a secure HTTPS connection to the collaborative document creation platform 122. The platform then processes the request, retrieves the relevant comments made within the specified time frame associated with the enterprise's user accounts, and returns them in a JSON-formatted response for processing by the data translation component 110 and stored in communication repository 112. A more detailed discussion of the data translation process is discussed in the context of FIG. 2.

In various examples, collaboration system interface 114 2 may issue API calls on a scheduled basis (e.g., daily) to ensure that comments are retrieved and archived regularly. Although the above description is discussed for the collaborative document creation platform 122, the enterprise server 102 may issue API calls to several external platforms. Each platform may have its own API format. As such, the collaboration system interface 114 may encode the parameters according to the format of the respective external platform.

Data store 120 may store data used by enterprise server 102 (e.g., communication repository 112, API formats, translation maps between API responses and formats used by the communication repository 112). Data store 120 is depicted as a singular element but may actually be multiple data stores. The specific storage layout and model used by data store 120 may take several forms—indeed, a data store 120 may utilize multiple models. Data store 120 may be but is not limited to, a relational database (e.g., SQL), a non-relational database (NoSQL), a flat-file database, an object model, a document details model, graph database, a shared ledger (e.g., blockchain), or a file system hierarchy. Data store 120 may store data on one or more storage devices (e.g., a hard disk, random access memory (RAM), etc.). The storage devices may be in standalone arrays, part of one or more servers, and located in one or more geographic areas.

Data structures may be implemented in several ways depending on the programming language of an application or the database management system used by an application. For example, if C++ is used, the data structure may implemented as a struct or class. In the context of a relational database, a data structure may be defined in a schema.

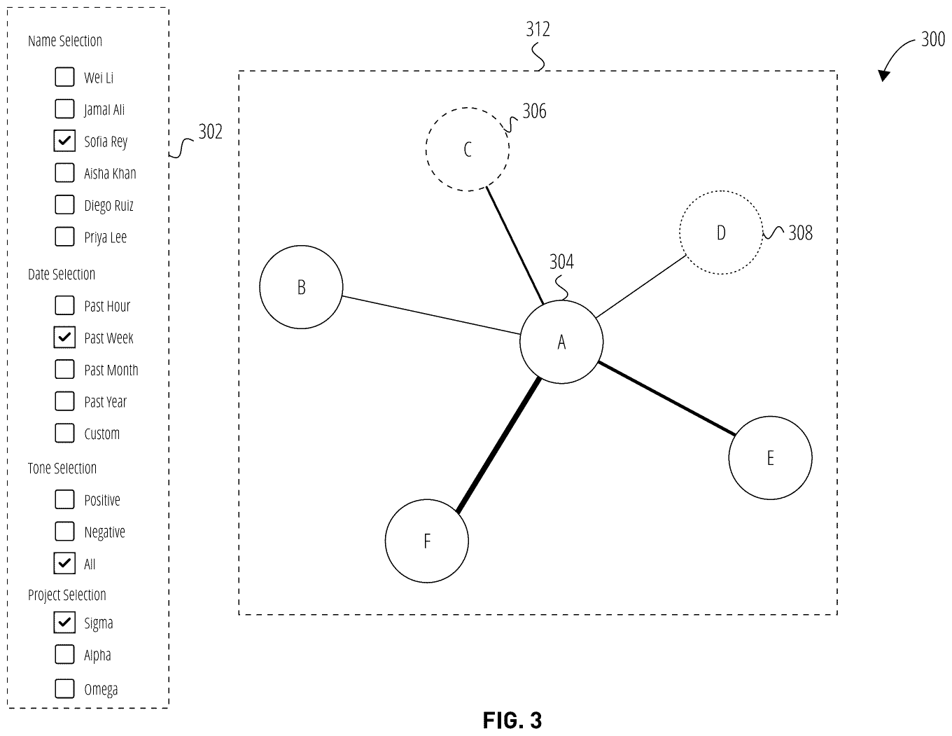

The communication metric visualizations 116 may generate visual representations of the communication data captured by the enterprise server 102 from the collaborative document creation platform 122. One such visualization technique may be a knowledge graph or a social network map of collaborators. This visualization maps the interactions between users within the platform environment or across the entire communication data set of the enterprise. A visualization of the knowledge graph may include the frequency and intensity of communications between individuals. For example, the graph could display nodes representing users, with edges between them indicating conversations or references within comments. The thickness of the lines might denote the volume of interactions, providing a visual indicator of the most active communication channels. An example visualization interface is presented and discussed further in FIG. 3.

Another visualization may be a dashboard that allows users to extract and analyze information from the communication repository 112. This dashboard may include features such as a comment word cloud, highlighting the most frequently mentioned terms or names within the comments. Users may interact with the word cloud to filter and display specific comments related to a selected term. Additionally, a visualization may include a timeline or heat map to show the ebb and flow of communication activity over time. Sudden spikes or drops in activity may signal important events or changes within the collaborative space, prompting further investigation.

In addition to ingesting comments from various collaborative document creation platforms, the enterprise server 102 may analyze the comments using communication analyzer 140 and machine learning models 144. The results may be used as styling for the visualization or incorporated into reports or recommendations output by recommendation engine 142.

The communication analyzer 140 may include sentiment analysis capabilities based on machine learning models 144 to classify the emotional content of communications. The machine learning models 144 may process textual data, including comments and feedback, to classify the emotional tone of messages (e.g., positive, neutral, or negative). In various examples, the sentiment analysis may be implemented using learning models trained on labeled communication datasets, combining both word embeddings and contextual features to understand emotional expressions.

The machine learning models 144 may track sentiment patterns over time (e.g., over a period of days or weeks) and across different communication channels, projects, and users to identify trends that may indicate underlying team dynamics. The models may analyze sentiment with other communication metrics, such as frequency and participant relationships, to provide a comprehensive view of team interactions. The communication analyzer 140 may generate visualizations or reports that display sentiment trends across projects, teams, or time periods. The communication analyzer 140 may aggregate this sentiment data to generate insights about team communication patterns and highlight areas (e.g., in visualization or text-based reports) where communication patterns for a project show sustained negative sentiment.

The communication analyzer 140 may work with recommendation engine 142 and machine learning models 144 to identify future communication patterns and potential issues. The models may analyze data like communication frequency, response times, and team engagement to detect unusual patterns (e.g., compared to a default baseline or changes above a certain percentage compared to a prior period) and make predictions about future trends.

In various examples, machine learning models 144 may use past communication patterns and identify when communications deviate from expected behavior. The models may examine factors like how often users communicate, how quickly they respond, and overall engagement levels to spot potential problems before they develop.

The machine learning models 144 may analyze historical communication pattern data alongside documented project outcomes, including whether projects were completed on time, delayed, or not completed. For example, when there is increased communication between specific participants, the models may correlate this pattern with outcomes such as delivering on time or experiencing a week's delay.

The models may document incidents by recording (e.g., in weights of neurons of a neural network) that when there is high communication volume between person A and person B, it typically leads to a delay of a week. In contrast, high communication between person A and person C usually means the project was completed before the expected time. This outcome data may be used to predict likely results when similar communication patterns are observed in future projects.

The data store may maintain structured records linking communication patterns to project completion metrics allowing the system to identify which interaction patterns historically correlate with successful on-time delivery versus delayed completion. The models may use these documented outcomes to adjust their predictive capabilities as new project completion data becomes available.

The recommendation engine 142 may use these predictions to identify possible communication bottlenecks or engagement issues. The engine may alert a supervisor user (e.g., via email or presented on a dashboard) when communication patterns suggest potential future problems or when team engagement appears to be declining. For example, if a current communication pattern matches (e.g., has a similar response frequency, overall communication frequency, similar negative sentiment) a known “bad” communication pattern, a supervisor may be alerted and given a recommended course of action. The prediction may be made using a model in machine learning models 144.

The communication analyzer 140 may monitor how (e.g., frequency, which collaborative document creation platforms, replies vs original comments) individual team members participate in communications over time to predict future engagement levels. The communication analyzer 140 may update its understanding of normal communication patterns as new communication data becomes available in communication repository 112, allowing it to adapt to changes in how teams communicate.

The data store 120 may maintain structured records of communication frequency trends and anomalies detected by the system. A frequency entry may be associated with one or more user identifiers, document IDs for specific documents or projects, content IDs for individual comments, and timestamp information.

In various examples, the data store 120 may store frequency metrics at different granularities, including hourly, daily, and weekly aggregations. Each metric record may include fields for typical baseline values, detected deviations, and confidence scores associated with identified anomalies. The data store 120 may maintain relationship mappings between users, documents, content items, and communication channels to enable multi-dimensional analysis of frequency patterns.

The recommendation engine 142 may generate recommendations based on analysis of communication patterns and user group dynamics. In various examples, recommendation engine 142 may suggest resource (e.g., personnel) allocation adjustments when detecting high (e.g., over a certain comment/day amount or 50% above baseline) communication volumes or delayed response patterns that indicate team overload. The recommendation engine 142 may analyze historical workload patterns and communication metrics to determine a resource-level recommendations.

The recommendation engine 142 may query data store 120 for current and past communication frequency and engagement levels to recommend team meetings or collaborative sessions. When recommendation engine 142 detects sustained periods of low (e.g., in absolute or relative terms) communication volume or declining participation rates, it may generate suggestions for specific types of team interactions. These suggestions may be based on an analysis of past successful intervention patterns.

In various examples, recommendation engine 142 may generate and maintain a library of communication templates designed for different scenarios. The templates may address situations such as project requirement clarification, team member re-engagement efforts, or status update requests. The engine may customize these templates based on project context, team composition, and historical communication patterns that showed positive outcomes. A template may include empty fields (e.g., usernames, project names, etc.), which may be automatically filled in by the recommendation engine 142 and transmitted to one or more associated parties (e.g., users in a team, a supervisor, etc.)

The recommendation engine 142 may track the implementation and effectiveness of its recommendations through feedback mechanisms and outcome measurements. It may adjust its recommendation strategies based on the observed success rates (e.g., if a project meets its deadline or communication increases) of different interventions and templates. The recommendation engine 142 may prioritize recommendations based on predicted impact levels and urgency indicators derived from the communication pattern analysis of communication analyzer 140.

The recommendation engine 142 may implement gamification features to track and encourage user engagement across communication platforms. The engine may calculate engagement scores based on quantifiable metrics including communication frequency, sentiment analysis results from the communication analyzer 140, and response timing patterns. The system may assign point values or achievement levels based on consistent participation, positive sentiment scores, and timely responses to communications.

In various examples, the recommendation engine 142 may generate automated recognition notifications when users reach engagement milestones or demonstrate sustained positive communication behaviors. The recommendation engine 142 may customize scoring criteria and achievement thresholds based on project context and historical patterns correlating with successful outcomes. For example, recommendation engine 142 may have leaderboards or progress indicators (visible via a website or app) to visualize engagement levels.

The recommendation engine 142 may analyze engagement metrics alongside other communication data to identify effective participation patterns. When the engine detects declining engagement scores, it may generate targeted recommendations or recognition opportunities to re-engage team members. The system may adjust scoring mechanisms and recognition thresholds based on observed correlations between engagement patterns and positive project outcomes.

FIG. 2 is a user interface and comment data structure, according to various examples. FIG. 2 includes document 202 which has comment indicator 206 and comment indicator 208 next to graphical elements. FIG. 2 further includes comment pane 204 with comment 210 and comment 212. As illustrated, comment indicator 206 maps to comment 210, and comment indicator 208 maps to comment 212. FIG. 2 further includes a JSON response 214 that may be sent in response to an API request.

The document 202 may be a document of a type managed by a collaborative document creation platform (e.g., collaborative document creation platform 122 in FIG. 1). A document may include content such as shapes, text, vector graphics, pictures, etc. A document may have multiple participants who are added to the document through an invitation process managed by the document owner or a participant with editing rights. The document owner may assign and revoke access rights, allowing certain participants to edit content and others with view-only permissions. This granular control over access rights ensures that the document's integrity is maintained while facilitating collaboration among participants with varying roles.

The collaborative document creation platform may track actions taken in the document. The actions may include modifying content, commenting on content, viewing the content, and a user being tagged in a comment. These actions may be recorded as metadata within the commenting system 124 or document data store 128. The metadata captures the details of each action, such as the type of action, the participant who performed it, timestamps, and any associated content changes or comment text.

For example, when a participant adds a comment to a document (e.g., as represented by comment indicator 206), the commenting system 124 logs the action by creating an entry in a commenting system that includes the comment's text, the author's identifier, the location within the document where the comment was made, and the time of the comment if the comment includes a tag of another user, this tagging action may also be recorded, linking the tagged individual to the comment.

Similarly, when a participant modifies the content of a document, the document data store (e.g., document data store 128) updates its records to reflect the changes. This may include the previous and new states of the content, allowing for version tracking and the ability to revert to earlier versions if necessary.

The JSON response 214 represents a portion of a response to an API call requesting comments made in the collaborative document creation platform. As illustrated in FIG. 2, the content and metadata associated with the comments are identified in a key-value pair format.

Regarding FIG. 1, consider that document 202 is part of the document data store 128 and the collaboration system interface 114 has transmitted a request for comments made in the past 24 hours. Upon receiving the API call, the collaborative document creation platform 122 processes the request. For example, the collaborative document creation platform 122 may query the commenting system 124 for comments associated with the specified user identifiers (or enterprise identifiers) and document identifiers that have changed within the given timeframe.

The results of the query may be compiled and transformed into an API response format with a data payload (e.g., as depicted in the JSON response 214). For example, the API response format may be a first data structure schema native to the collaborative document creation platform 122. This data payload is sent back to the enterprise server 102, where the data translation component 110 may then parse it.

The data translation component 110 on the enterprise server 102 may transform the received data payload into a format compatible with the enterprise's systems, such as the communication repository 112. The data translation component 110 may parse the data payload of comments, extracting relevant information like the timestamps, content, and associated user identifiers. If a comment references another user, as in the example “@Jane, please look at the design of this component,” the data translation component 110 may add two entries or a single entry with both the author's and the mentioned user's identifiers. The parsed data may be transformed into a second data structure schema, which is suitable for the enterprise's archival purposes, and stored in the communication repository 112.

The data translation component 110 may employ a set of business rules to discern which interactions qualify as communications for regulatory purposes before inclusion in the communication repository 112. The rules may align with regulatory definitions and company policies regarding what constitutes a recordable communication. For instance, the component might be configured to recognize explicit interactions such as comments containing questions, answers, or actionable items as communications. Conversely, it may exclude being a participant in a document with nothing more.

Consider the comments in JSON response 214 as an example of a translation. Upon receiving the JSON response from the collaborative document creation platform 122, the data translation component 110 may begin the parsing process by iterating over each comment object within the comments array. A JSON parser may be used to navigate the structure of the response.

For each comment, the data translation component 110 retrieves the document_id, comment_id, text, author details (including user_id, name, and email), and timestamp. This information is then mapped to the corresponding fields in the data structure schema used by the communication repository 112. For example, the schema may be an XML schema.

The mapping may include translating the JSON fields into XML elements and attributes. For example, the document_id in the JSON object becomes an attribute of a document element in the XML file, and the text of the comment is encapsulated within a commentText element. As an example, a resulting XML structure for the fourth comment might look something like:

<comments>
<comment>
<document_id>doc-123</document_id>
<comment_id>cmt-456</comment_id>
<text>Can we adjust the color scheme to align with our brand
guidelines?</text>
<author>
<user_id>user-789</user_id>
<name>Jane Doe</name>
<email>jane.doe @ enterprise.com </email>
</author>
<timestamp>2023-04-01T10:15:30Z</timestamp>
</comment>
</comments>

More or fewer fields may be used in the XML as may be appreciated. For example, as several external services may be used, a comment entry in the XML may include a service identifier (e.g., of collaborative document creation platform 122). Thus, comments from multiple collaborative platforms may be collected. Other fields may include, but are not limited to a project identifier and a comment type (e.g., an original comment or a reply to an existing comment).

Additionally, the data structure schema may include elements for the results of analysis by communication analyzer 140. For example, a comment entry may include a sentiment as determined by machine learning models 144, as discussed previously.

FIG. 3 is an interactive communication analysis user interface, according to various examples. The communication analysis user interface 300 may be served to a user from a web server (e.g., web server 106). The communication analysis user interface may include filter selections 302 and a graph visualization portion that includes communication network visualization 312.

The web server 106 may transmit a web page containing the user interface to a client device in response to receiving user credentials. Upon authentication, the communication metric visualizations 116 may generate a communication network visualization 312 where nodes represent users and edge connections represent communications between them.

In various examples, the communication metric visualizations 116 may process filter selections 302 to customize the graph presentation. For example, the filter selections 302 may include a user selector, a project selector, a date range selector, and a collaborative document creation platform selector. Processing may include submitting database queries to data store 120 per the selections made. When a user makes a new selection, a new database query may be made, or an existing received set of communications may be further filtered to create a filtered communication set. The communication network visualization 312 may then be updated accordingly.

When a user selection is made, such as Sofia Rey, that user's node may be positioned as the central node A (node 304) in the visualization, with connected nodes B-F representing other users with whom they have communicated. If a new user is selected, that user may become the central node. The thickness of edges between nodes may indicate the volume of communications, providing visual indicators of interaction frequency. The volume may be absolute or relative to the plurality of communications received in response to the database query.

The tone selection filter may enable visualization of sentiment patterns, with options to display all communications or filter for specific sentiment classifications. The project selection, such as “Sigma,” may restrict the visualization to communications associated with particular projects or workspaces. The system may update the visualization dynamically as filter selections are modified.

In various examples, the communication network visualization 312 may incorporate additional metrics such as response times and engagement levels through visual elements like node size or edge styling. The interface may provide interactive capabilities, allowing users to adjust the visualization parameters and explore different aspects of the communication network.

The communication metric visualizations 116 may also implement multiple visual formatting styles to represent different communication characteristics in the network graph. The node outlines may vary in style, with node 306 using dashed lines and node 308 using dotted lines to indicate different communication patterns or sentiment trends.

The communication metric visualizations 116 may calculate aggregate sentiment scores from the communication analyzer 140's analysis results stored in data store 120. These scores may be mapped to visual attributes, such as node border styles, line patterns, colors, node shapes, and edge weights. The visualization may implement a standardized mapping between sentiment ranges and visual elements—for example, longer dashes for more positive sentiment scores and shorter dashes or dots for neutral or negative sentiments.

Other visualizations may be used as well. For example, communication metric visualizations 116 may generate heat map overlays based on communication density. The visualization may use color gradients to represent areas of high and low communication activity, with darker or more intense colors indicating higher frequency interactions. The date selection filter may allow temporal analysis ranging from hourly to yearly views, with options for custom date ranges to examine specific periods.

Although FIG. 3 only illustrates a single graph visualization, multiple visualizations may be presented simultaneously, with each project, collaborative document creation platform, or other entity potentially represented by a distinct visualization. In these cases, the graphic visualization is simplified, employing letters representing nodes, whereas user names may be displayed in alternative formats.

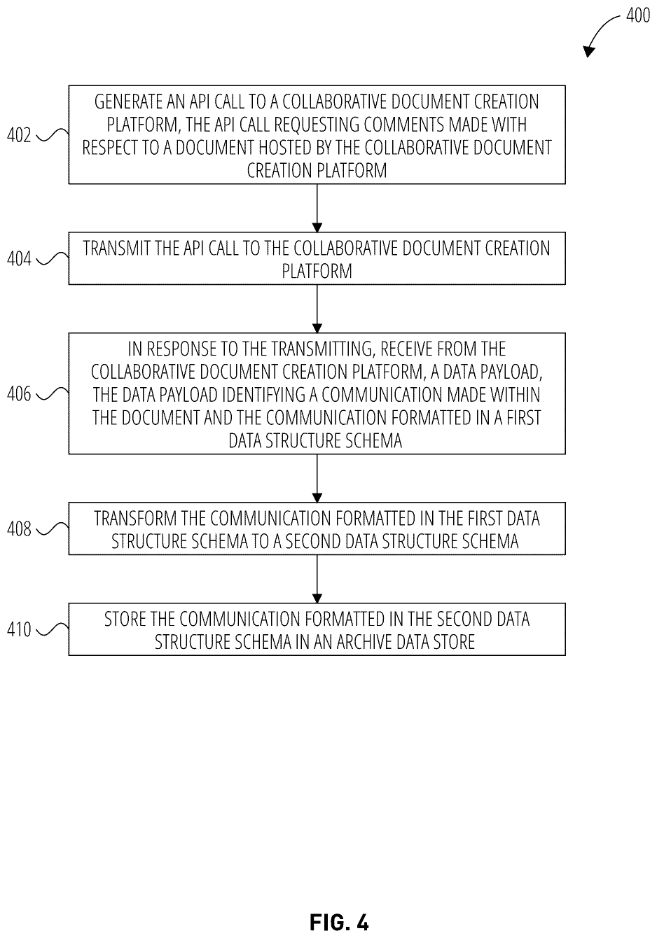

FIG. 4 is a flowchart illustrating a method to translate comments between data structure schemas, according to various examples. The method is represented as a set of blocks that describe operations 402 to 410. The method may be embodied in a set of instructions stored in at least one computer-readable storage device of a computing device. A computer-readable storage device excludes transitory signals. In contrast, a signal-bearing medium may include such transitory signals. A machine-readable medium may be a computer-readable storage device or a signal-bearing medium. A processing unit, which executes the set of instructions, may configure the processing unit to perform the operations illustrated in FIG. 4. The processing unit may instruct another component of a computing device to carry out the set of instructions. For example, the processing unit may instruct a network device to transmit data to another computing device or the computing device may provide data over a display interface to present a user interface. In some examples, the performance of the method may be split across multiple computing devices using a shared computing infrastructure (e.g., the processing unit encompasses multiple distributed computing devices).

In operation 402, the method of flowchart 400 includes generating an API call to a collaborative document creation platform, the API call requesting comments made with respect to a document hosted by the collaborative document creation platform. For example, collaboration system interface 114 may use the format of API 126 to generate the API call. As illustrated in FIG. 1, the collaborative document creation platform 122 maintains these comments through the commenting system 124, which tracks feedback, discussions, and annotations within documents stored in the document data store 128.

In operation 404, the method of flowchart 400 includes transmitting the API call to the collaborative document creation platform. As part of the transmitting process, different parameters may be encoded in the request such as a set of user identifiers, an enterprise identifier, a type of content, a time period, etc. The API call may be structured to retrieve comment data in a format shown in FIG. 2's JSON response 214, which includes fields for document IDs, comment IDs, text content, author information, and timestamps. The commenting system 124 may process these parameters to identify and return the relevant comments associated with the enterprise's user accounts in user accounts 130.

In operation 406, the method of flowchart 400 includes in response to the transmitting, receives from the collaborative document creation platform, a data payload, the data payload identifying a communication made within the document and the communication formatted in a first data structure schema. The data payload identifying the communication made within the document may be part of a plurality of communications identified in the data payload.

In various examples, the plurality of communications may be filtered to exclude communications that do not meet a threshold level of classification as an archivable communication. For example, a set of business rules as discussed with respect to the data translation component 110 may be used to calculate a score (e.g., a probability) that a communication should be archived.

In operation 408, the method of flowchart 400 includes transforming the communication formatted in the first data structure schema to a second data structure schema. This operation may involve the use of data transformation algorithms or services that map the fields from the first schema to the corresponding fields in the second schema. The transformation process may include parsing the communication to retrieve a user identifier of the creator of the communication and the content (e.g., a comment) of the communication, as well as identifying any additional user identifiers mentioned within the content.

As illustrated in FIG. 2, this transformation process may convert a JSON response 214, which contains fields like document_id, comment_id, text, and author details, into a different schema. The data translation component 110 may convert the data payload into a format compatible with an enterprise's systems, such as the communication repository 112. For example, the JSON fields may be mapped to XML elements and attributes, where the document_id becomes an attribute of a document element, and the text of the comment is encapsulated within a commentText element.

A translation map may be accessed between fields in the first data structure schema to field in the second data structure schema. The data translation component 110 of FIG. 1 may perform the transformation of the communication. An entry with the transformed data may be generated that includes the user identifier and content in accordance with the second data structure schema.

In operation 410, the method of flowchart 400 stores the communication formatted in the second data structure schema in an archive data store. As shown in FIG. 1, this storage operation may include storing the transformed communication data into communication repository 112, which serves as the archive data store for the enterprise server 102. The stored communications may include metadata such as sentiment analysis results from the communication analyzer 140 and machine learning models 144. The communication repository 112 maintains these records in a format suitable for regulatory compliance, storing structured records of communication frequency trends and anomalies detected by the system. For example, each stored communication may include fields for normal baseline values, detected deviations, and confidence scores associated with identified anomalies, as well as relationship mappings between users, documents, content items, and communication channels to enable multi-dimensional analysis of communication patterns.

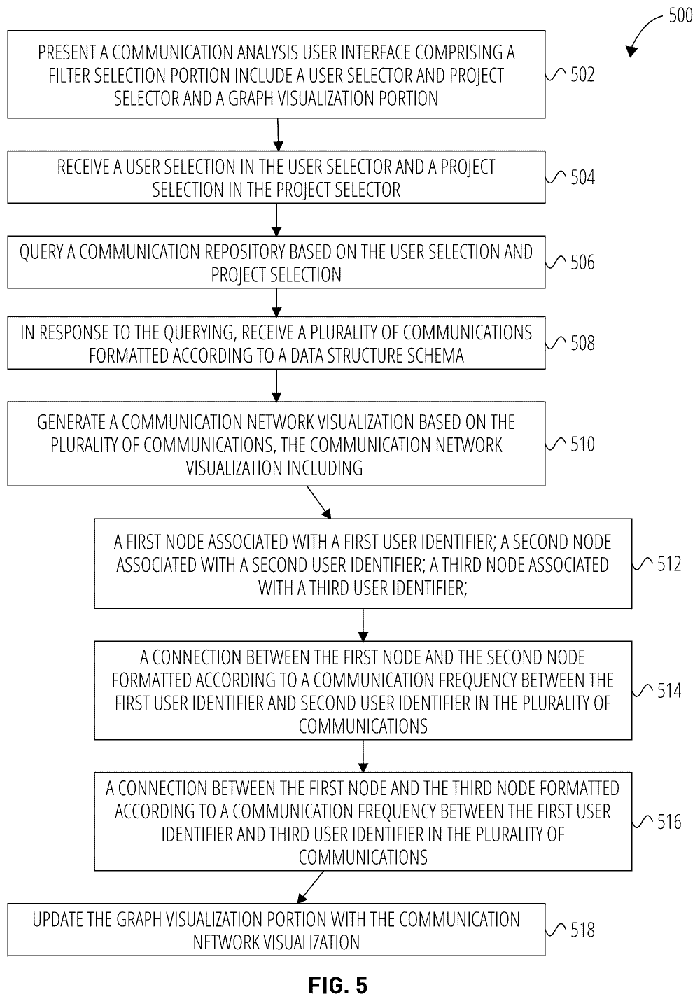

FIG. 5 illustrates an example method 500 for generating a communication network visualization, according to various examples. Although the example method 500 depicts a sequence of operations, the sequence may be altered without departing from the scope of the present disclosure. The method may be embodied in a set of instructions stored in at least one computer-readable storage device of a computing device. A computer-readable storage device excludes transitory signals. In contrast, a signal-bearing medium may include such transitory signals. A machine-readable medium may be a computer-readable storage device or a signal-bearing medium. A processing unit, which executes the set of instructions, may configure the processing unit to perform the operations illustrated in FIG. 5. The processing unit may instruct another component of a computing device to carry out the set of instructions. For example, the processing unit may instruct a network device to transmit data to another computing device or the computing device may provide data over a display interface to present a user interface. In some examples, the performance of the method may be split across multiple computing devices using a shared computing infrastructure (e.g., the processing unit encompasses multiple distributed computing devices).

According to some examples, the method includes presenting a communication analysis user interface comprising a filter selection portion that includes a user selector and project selector and a graph visualization portion at block 502. For example, the communication analysis user interface may be one as presented in FIG. 3.

According to some examples, the method includes receiving a user selection in the user selector and a project selection in the project selector at block 504. A user selection may be made by the user clicking on a checkbox, selecting from a drop-down, etc.

According to some examples, the method includes querying a communication repository based on the user selection and project selection at block 506. For example, a query may be made to communication repository 112 for comments that match the project selection and have been made by or to the user noted in the user selection.

According to some examples, the method includes, in response to the querying, receiving a plurality of communications formatted according to a data structure schema at block 508. The data structure schema may be one such as discussed in FIG. 2 and include data beyond the comments text such as a classified sentiment. In various examples, the plurality of communications includes communications from a plurality of collaborative document creation platforms for the project selection.

According to some examples, the method includes generating a communication network visualization based on the plurality of communications, the communication network visualization at block 510. The visualization may be generated in part using a graph generation user interface framework (e.g., Gephi).

According to some examples, the communication network visualization includes a first node associated with a first user identifier; a second node associated with a second user identifier; a third node associated with a third user identifier at block 512. The first user identifier may be placed at the center of the communication network visualization in various examples.

In various examples, the first node may be formatted according to a sentiment analysis of communications attributable to the first user identifier in the plurality of communications (e.g., as discussed for FIG. 3).

According to some examples, the communication network visualization includes a connection between the first node and the second node formatted according to a communication frequency between the first user identifier and second user identifier in the plurality of communications at block 514.

According to some examples, the method includes a connection between the first node and the third node formatted according to a communication frequency between the first user identifier and third user identifier in the plurality of communications at block 516.

According to some examples, the method includes updating the graph visualization portion with the communication network visualization at block 518.

In various examples, the communication analysis user interface includes a date range selector. The method may also include receiving a date selection from the date range selector, and filtering communications from the plurality of communications based on the date selection; and updating the formatting of the connection between the first node and the second node in the communication network visualization according to a communication frequency between the first user identifier and second user identifier in the filtered communications.

In various examples, the communication analysis user interface includes a recommendation portion. The method may also include selecting a communication template from a plurality of communication templates based on a communication between user identifiers in the plurality of communications for the project selection, and presenting the communication template in the recommendation portion, receiving a selection of the communication template, and in response to the receiving, transmitting a message to the first user identifier based on the communication template.

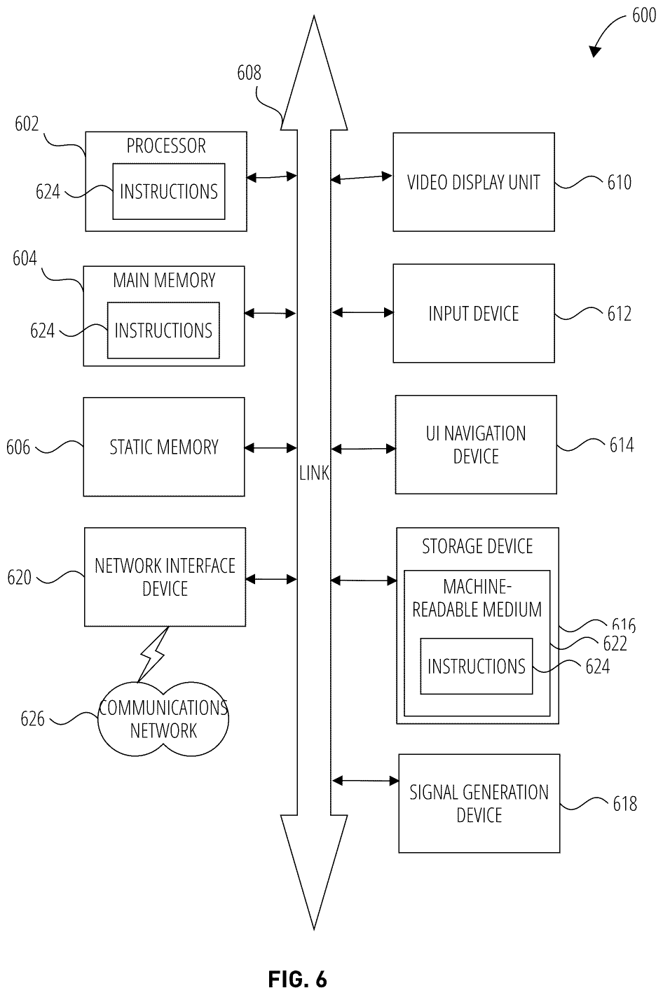

FIG. 6 is a block diagram illustrating a machine in the example form of computer system 600, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client Network environments, or it may act as a peer machine in peer-to-peer (or distributed) Network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via a link 608. The computer system 600 may further include a video display unit 610, an input device 612 (e.g., a keyboard), and a user interface UI navigation device 614 (e.g., a mouse). In one embodiment, the video display unit 610, input device 612, and UI navigation device 614 are incorporated into a single device housing such as a touch screen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensors.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed Database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 622 that excluded transitory signals.

The instructions 624 may further be transmitted or received over a communications network 626 using a transmission medium via the network interface device 620 utilizing any one of a number of well-known transfer protocols (e.g., HTTP). Examples of communication networks include a local area Network (LAN), a wide area Network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Example 1 is a method comprising: generating an API call to a collaborative document creation platform, the API call requesting comments made with respect to a document hosted by the collaborative document creation platform; transmitting the API call to the collaborative document creation platform; in response to the transmitting, receiving from the collaborative document creation platform, a data payload, the data payload identifying a communication made within the document and the communication formatted in a first data structure schema; transforming the communication formatted in the first data structure schema to a second data structure schema; and storing the communication formatted in the second data structure schema in an archive data store.

In Example 2, the subject matter of Example I includes, wherein transmitting the API call to the collaborative document creation platform includes: encoding a set of user identifiers in the API call; and encoding a time period in the API call.

In Example 3, the subject matter of Examples 1-2 includes, wherein transforming the communication formatted in the first data structure schema to the second data structure schema includes: parsing the communication in accordance with the first data structure schema to retrieve a user identifier of a creator of the communication and content of the communication; and generating an entry including user identifier and content in accordance with the second data structure schema.

In Example 4, the subject matter of Example 3 includes, wherein transforming the communication formatted in the first data structure schema to the second data structure schema further includes: parsing the communication for identification of another user identifier mentioned in the content.

In Example 5, the subject matter of Examples 1-4 includes, wherein transforming the communication formatted in the first data structure schema to the second data structure schema includes: accessing a translation map between fields in the first data structure schema to fields in the second data structure schema.

In Example 6, the subject matter of Examples 1-5 includes, wherein the data payload identifying the communication made within the document is received from the collaborative document creation platform as part of a plurality of communications identified in the data payload.

In Example 7, the subject matter of Example 6 includes, filtering the plurality of communications according to exclude communications that do not meet a threshold level of classification as an archivable communication.

In Example 8, the subject matter of Examples 1-7 includes, wherein the communication made within the document is a comment made with respect to the document.

Example 9 is a method comprising: presenting a communication analysis user interface comprising: a filter selection portion including a user selector and project selector; and a graph visualization portion; receiving a user selection in the user selector and a project selection in the project selector; querying a communication repository based on the user selection and project selection; in response to the querying, receiving a plurality of communications formatted according to a data structure schema; generating a communication network visualization based on the plurality of communications, the communication network visualization including: a first node associated with a first user identifier; a second node associated with a second user identifier; a third node associated with a third user identifier; a connection between the first node and the second node formatted according to a communication frequency between the first user identifier and second user identifier in the plurality of communications; and a connection between the first node and the third node formatted according to a communication frequency between the first user identifier and third user identifier in the plurality of communications; and updating the graph visualization portion with the communication network visualization.

In Example 10, the subject matter of Example 9 includes, wherein the communication analysis user interface includes a date range selector.

In Example 11, the subject matter of Example 10 includes, receiving a date selection from the date range selector; and filtering communications from the plurality of communications based on the date selection; and updating the formatting of the connection between the first node and the second node in the communication network visualization according to a communication frequency between the first user identifier and second user identifier in the filtered communications.

In Example 12, the subject matter of Examples 9-11 includes, formatting the first node according to a sentiment analysis of communications attributable to the first user identifier in the plurality of communications.

In Example 13, the subject matter of Examples 9-12 includes, wherein the communication analysis user interface includes a recommendation portion.

In Example 14, the subject matter of Example 13 includes, selecting a communication template from a plurality of communication templates based on a communication between user identifiers in the plurality of communications for the project selection; and presenting the communication template in the recommendation portion; receiving a selection of the communication template; and in response to the receiving, transmitting a message to the first user identifier based on the communication template.

In Example 15, the subject matter of Examples 9-14 includes, wherein the plurality of communications include communications from a plurality of collaborative document creation platforms for the project selection.

Example 16 is at least one machine-readable medium including instructions that, when executed by processing circuitry, cause the processing circuitry to perform operations to implement of any of Examples 1-15.

Example 17 is an apparatus comprising means to implement of any of Examples 1-15.

Example 18 is a system to implement of any of Examples 1-15.

Example 19 is a method to implement of any of Examples 1-15.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A method comprising:
generating an API call to a collaborative document creation platform, the API call requesting comments made with respect to a document hosted by the collaborative document creation platform;
transmitting the API call to the collaborative document creation platform;
in response to the transmitting, receiving from the collaborative document creation platform, a data payload, the data payload identifying a communication made within the document and the communication formatted in a first data structure schema;
transforming the communication formatted in the first data structure schema to a second data structure schema; and
storing the communication formatted in the second data structure schema in an archive data store.

2. The method of claim 1, wherein transmitting the API call to the collaborative document creation platform includes:
encoding a set of user identifiers in the API call; and
encoding a time period in the API call.

3. The method of claim 1, wherein transforming the communication formatted in the first data structure schema to the second data structure schema includes:
parsing the communication in accordance with the first data structure schema to retrieve a user identifier of a creator of the communication and content of the communication; and
generating an entry including user identifier and content in accordance with the second data structure schema.

4. The method of claim 3, wherein transforming the communication formatted in the first data structure schema to the second data structure schema further includes:
parsing the communication for identification of another user identifier mentioned in the content.

5. The method of claim 1, wherein transforming the communication formatted in the first data structure schema to the second data structure schema includes:
accessing a translation map between fields in the first data structure schema to fields in the second data structure schema.

6. The method of claim 1, wherein the data payload identifying the communication made within the document is received from the collaborative document creation platform as part of a plurality of communications identified in the data payload.

7. The method of claim 6, further comprising:
filtering the plurality of communications according to exclude communications that do not meet a threshold level of classification as an archivable communication.

8. The method of claim 1, wherein the communication made within the document is a comment made with respect to the document.

9. A system comprising:
a processing unit; and
a storage device comprising instructions, which when executed by the processing unit configure the processing unit to perform operations comprising:
generating an API call to a collaborative document creation platform, the API call requesting comments made with respect to a document hosted by the collaborative document creation platform;
transmitting the API call to the collaborative document creation platform;
in response to the transmitting, receiving from the collaborative document creation platform, a data payload, the data payload identifying a communication made within the document and the communication formatted in a first data structure schema;
transforming the communication formatted in the first data structure schema to a second data structure schema; and
storing the communication formatted in the second data structure schema in an archive data store.

10. The system of claim 9, wherein transmitting the API call to the collaborative document creation platform includes:
encoding a set of user identifiers in the API call; and
encoding a time period in the API call.

11. The system of claim 9, wherein transforming the communication formatted in the first data structure schema to the second data structure schema includes:
parsing the communication in accordance with the first data structure schema to retrieve a user identifier of a creator of the communication and content of the communication; and
generating an entry including user identifier and content in accordance with the second data structure schema.

12. The system of claim 11, wherein transforming the communication formatted in the first data structure schema to the second data structure schema further includes:
parsing the communication for identification of another user identifier mentioned in the content.

13. The system of claim 9, wherein transforming the communication formatted in the first data structure schema to the second data structure schema includes:
accessing a translation map between fields in the first data structure schema to fields in the second data structure schema.

14. The system of claim 9, wherein the data payload identifying the communication made within the document is received from the collaborative document creation platform as part of a plurality of communications identified in the data payload.

15. The system of claim 14, wherein the instructions, which when executed by the processing unit, further configure the processing unit to perform operations comprising:
filtering the plurality of communications according to exclude communications that do not meet a threshold level of classification as an archivable communication.

16. The system of claim 9, wherein the communication made within the document is a comment made with respect to the document.

17. A non-transitory computer-readable medium comprising instructions, which when executed by a processing unit, configure the processing unit to perform operations comprising:
generating an API call to a collaborative document creation platform, the API call requesting comments made with respect to a document hosted by the collaborative document creation platform;
transmitting the API call to the collaborative document creation platform;
in response to the transmitting, receiving from the collaborative document creation platform, a data payload, the data payload identifying a communication made within the document and the communication formatted in a first data structure schema;
transforming the communication formatted in the first data structure schema to a second data structure schema; and
storing the communication formatted in the second data structure schema in an archive data store.

18. The non-transitory computer-readable medium of claim 17, wherein transmitting the API call to the collaborative document creation platform includes:
encoding a set of user identifiers in the API call; and
encoding a time period in the API call.

19. The non-transitory computer-readable medium of claim 17, wherein transforming the communication formatted in the first data structure schema to the second data structure schema includes:
parsing the communication in accordance with the first data structure schema to retrieve a user identifier of a creator of the communication and content of the communication; and
generating an entry including user identifier and content in accordance with the second data structure schema.

20. The non-transitory computer-readable medium of claim 19, wherein transforming the communication formatted in the first data structure schema to the second data structure schema further includes:
parsing the communication for identification of another user identifier mentioned in the content.
